(19) United States
(12) Patent Application Publication
(10) Pub. No.: US 2011/0164510 A1
(43) Pub. Date: Jul. 7, 2011

(54) METHOD AND SYSTEM FOR SELECTING A USER GROUP USING QUANTIZED CHANNEL STATE INFORMATION FEEDBACKS FROM MIMO CAPABLE MOBILE DEVICES

(76) Inventors: Jun Zheng, San Diego, CA (US); Mark Kent, Vista, CA (US); Vinko Erceg, Cardiff, CA (US)

(21) Appl. No.: 12/652,124

(22) Filed: Jan. 5, 2010

(51) Int. Cl. H04B 15/00; H04L 12/26; H04W 4/00

(52) U.S. Cl. 370/252; 370/329; 375/285

(57) ABSTRACT

A mobile device estimates channel status information (CSI) for an associated single user downlink multiple-input multiple-output (MIMO) channel. The estimated CSI is quantized using a finite quantization resolution. The quantized CSI is communicated to the base station over a finite-rate feedback channel. Intended downlink data transmission is scheduled by the base station according to the transmitted CSI, and received by the mobile device, accordingly. The estimated CSI comprise generalized channel quality information such as channel capacity and channel direction. The base station selects a first user having a strongest channel capacity according to quantized CSI received from associated mobile devices. Beams orthogonal to a single user downlink MIMO channel of the selected first user are broadcasted. Quantized relative channel direction matrices and projected channel capacity are received from remaining mobile devices. A user having a strongest projected channel capacity is selected a second user for the user group.

### CROSS-REFERENCE TO RELATED APPLICATIONS/INCORPORATION BY REFERENCE

This application makes reference to:
U.S. patent application Ser. No. 11/232,340 filed on Sep. 21, 2005;
U.S. application Ser. No. 11/232,266 filed on Sep. 21, 2005;
U.S. application Ser. No. 11/231,501 filed on Sep. 21, 2005; and
U.S. patent application Ser. No. ______ (Attorney Docket No. 20849US01) filed on even date herewith.

Each of the above stated applications is hereby incorporated herein by reference in its entirety.

### FIELD OF THE INVENTION

Certain embodiments of the invention relate to signal processing for communication systems. More specifically, certain embodiments of the invention relates to a method and system for selecting a user group using quantized channel state information feedbacks from MIMO capable mobile devices.

### BACKGROUND OF THE INVENTION

Wireless communication systems are widely deployed to provide various types of communication such as voice and data for a number of associated users. These systems may be implemented based on various access techniques such as, for example, code division multiple access (CDMA), time division multiple access (TDMA), frequency division multiple access (FDMA), or some other multiple access techniques.

A multiple-input multiple-output (MIMO) communication system employs multiple transmit (N_{T}) antennas and multiple receive (N_{R}) antennas for communicating multiple spatially independent data streams. In an exemplary MIMO downlink communication system, the transmitter (e.g., a base station) is provided with multiple antennas capable of transmitting multiple spatially independent data streams, while the receiver (e.g., a mobile device) is equipped with multiple receive antennas to receive one or more of the multiple spatially independent data streams transmitted by the base station. The connection between the multiple-antenna base station and a single multiple-antenna mobile device is called a MIMO channel, which is formed by multiple transmit (N_{T}) antennas and multiple receive (N_{R}) antennas. A MIMO channel may be decomposed into N_{C} independent channels, with N_{C≦}min {N_{T}, N_{R}}. Each of the N_{C} independent channels is referred to as a spatial subchannel of the MIMO channel. Different MIMO channels experience different link characteristics and are associated with different transmission capability.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and/or system for selecting a user group using quantized channel state information feedbacks from MIMO capable mobile devices, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram of an exemplary multiple-input-multiple-output (MIMO) communication system that is operable to perform user group selection using quantized channel state information from MIMO capable mobile devices, in accordance with an embodiment of the invention.

FIG. 2 is a block diagram illustrating an exemplary MIMO downlink transmission system that is operable to schedule downlink data transmissions to MIMO capable mobile devices according to corresponding quantized channel state information, in accordance with an embodiment of the invention.

FIG. 3 is a flow diagram illustrating exemplary steps that are utilized to generate quantized channel state information for selecting a user group from MIMO capable mobile devices, in accordance with an embodiment of the invention.

FIG. 4 is a flow diagram illustrating exemplary steps for selecting a user group from MIMO capable mobile devices using quantized channel state information, in accordance with an embodiment of the invention.

### DETAILED DESCRIPTION OF THE INVENTION

Certain embodiments of the invention may be found in a method and system for selecting a user group using quantized channel state information feedbacks from MIMO capable mobile devices. In various embodiments of the invention, a mobile device is operable to estimate channel status information (CSI) for an associated single user downlink multiple-input multiple-output (MIMO) channel. The mobile device is operable to quantize the estimated CSI and communicate the quantized estimated CSI to the base station over a finite-rate feedback channel. The downlink data transmission intended for the mobile device may be scheduled by the base station according to the transmitted CSI. The mobile device is operable to receive the scheduled downlink data transmission, accordingly. The estimated CSI comprises generalized channel quality information such as, for example, channel gain, channel direction, channel quality indicator (CQI), signal-to-noise ratio (SNR), signal-to-noise-interference ratio (SNIR), channel capacity, and/or channel maximum mutual information rate associated with the single user downlink MIMO channel.

The mobile device is operable to quantize the estimated CSI for the single user downlink MIMO channel using a finite quantization resolution such as a quantization resolution of one bit. The base station is operable to receive quantized CSI over the feedback channel from a plurality of associated communication devices. The base station may examine the received quantized CSI and select a first user having a strongest channel capacity from the plurality of associated mobile devices. A complementary orthogonal matrix corresponding to a single user downlink MIMO channel from the base station to the selected first user is calculated. Beams orthogonal to the downlink MIMO channel from the base station to the selected first user, which are indicated in the calculated complementary orthogonal matrix, may be broadcasted to the entire serving area of the base station. Each remaining mobile device is operable to generate a quantized relative channel direction matrix and quantized projected channel capacity with respect to the broadcast complementary orthogonal matrix. The generated quantized relative channel direction matrix and quantized projected channel capacity are transmitted to the base station over the feedback link. A mobile device having a strongest projected channel capacity is selected as a second user for the user group.

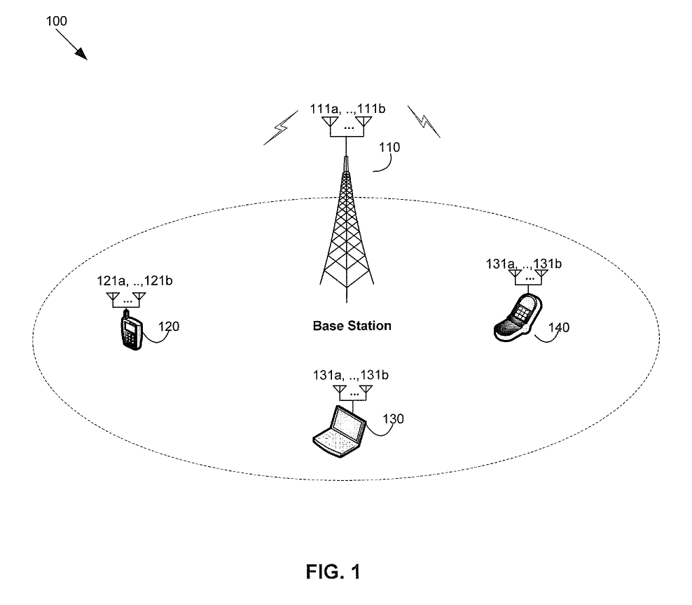

FIG. 1 is a diagram of an exemplary multiple-input-multiple-output (MIMO) communication system that is operable to perform user group selection using quantized channel state information from MIMO capable mobile devices, in accordance with an embodiment of the invention. Referring to FIG. 1, there is shown a MIMO communication system 100. The MIMO communication system 100 comprises a base station 110 and a plurality of associated mobile devices, of which mobile devices 120-140 are illustrated. The base station 110 comprises multiple available transmit antennas 111a-111b. Each of the mobile devices 120-140 is equipped with multiple available receive antennas, for example, receive antennas 121a-121b, receive antennas 131a-131b, or receive antennas 141a-141b.

The base station 110 may comprise suitable logic, circuitry, interfaces and/or code that may be operable to perform air interface processing and schedule communication resources such as spectrum and/or time slots in both uplink communications and downlink communications to various associated mobile devices such as the mobile device 120 in a timely manner. The base station 110 may be operable to determine which associated mobile device may receive a data packet and at what time the receiving should occur. The base station 110 may be operable to concurrently communicate with a plurality of associated mobile devices such as the mobile devices 120-140. In this regard, base station 110 may be operable to employ multiple available transmit antennas, for example, the transmit antennas 111a-111b, to communicate multiple spatially independent data streams with one or more multi-antenna mobile devices such as the mobile devices 120-140. In this regard, the base station 110 may be operable to communicate multiple spatially independent data streams over one or more single user downlink MIMO channels. A single user downlink MIMO channel is formed by multiple transmit (N_{T}) antennas at the base station 110 and multiple receive antennas equipped on a single mobile device such as the mobile device 120. Channel state information (CSI) for corresponding single user downlink MIMO channels may be received or reported from the mobile devices 120-140. The received CSI may comprise corresponding single user downlink MIMO channel quality information. Specifically, the received CSI may comprise channel quality information for each spatial subchannel of corresponding single user downlink MIMO channels. For example, in instances where the base station 110 may be equipped with M available transmit antennas and the mobile device 120 may have N available receive antennas, the single user downlink MIMO channel between the base station 110 and the mobile device 120 comprises M×N spatial subchannels. Accordingly, the received CSI from the mobile device 120 may be represented as an M×N CSI matrix. Channel quality information may comprise, for example, channel capacity or rate, signal to noise ratios (SNRs), channel quality indicator (CQI), channel gain and/or channel direction information. The CSI received from the mobile device 120 may indicate average channel quality information over the entire M×N spatial subchannels.

The base station 110 may be operable to receive CSI from the mobile devices 120-140 over a finite-rate feedback link. In this regard, quantized CSI may be received over the finite-rate link from the mobile devices 120-140. The received quantized CSI may comprise corresponding quantized MIMO channel quality information such as, for example, quantized signal to noise ratios (SNRs), quantized CQI, and/or quantized channel capacity and/or quantized channel direction information. Specifically, the received CSI may comprise quantized channel quality information for each spatial subchannel of corresponding single user downlink MIMO channels. For the base station 110 with M available transmit antennas and a multi-antenna mobile device with N available receive antennas, the CSI received from the mobile device 120 may be an M×N CSI matrix indicating average channel quality information over the entire M×N spatial subchannels. The base station 110 may be operable to process or decode the received quantized CSI for scheduling downlink data transmissions. In this regard, the base station 110 may be operable to manage and/or control downlink data transmissions according to corresponding processed CSI.

One or more multi-antenna mobile devices such as the mobile device 120-140 may be selected to form a user group for downlink data transmissions. In this regard, the base station 110 may be operable to select a multi-antenna mobile device, for example, the mobile device 120, having the strongest channel capacity as a first user in the user group. The base station 110 may be operable to send a request to the selected first user (the mobile device 120) for channel direction information specific to a MIMO channel between the base station 210 and the selected first user, i.e., the mobile device 120. Subsequently, the base station 110 may be operable to receive quantized channel direction information from the mobile device 120.

The received quantized channel direction information may comprise quantized channel direction information for each spatial subchannel of the MIMO channel between the base station 210 and the mobile device 120. The quantized channel direction information received from the mobile device 120 may be a channel direction matrix indicating average channel direction information over the entire associated spatial subchannels. The base station 110 may be operable to calculate a complementary orthogonal matrix for the received channel direction matrix from the selected first user (the mobile device 120). The base station 110 may be operable to broadcast the calculated complementary orthogonal matrix, which indicates beams that are approximately orthogonal to beams that are associated with the MIMO channel between the base station 210 and the selected first user, i.e., the mobile device 120.

The base station 110 may be operable to receive channel direction information and channel capacity with respect to the broadcast complementary orthogonal matrix over the finite-rate feedback channel from the remaining mobile devices. In this regard, the received channel direction information may comprise a quantized channel direction matrix and quantized channel capacity with respect to the broadcast complementary orthogonal matrix from each of the remaining mobile devices. The received quantized channel direction matrices indicate relative direction deviation of beams of corresponding single user downlink MIMO channel are semi-orthogonal (approximately orthogonal) with respect to the beams associated with the single user downlink MIMO channel between the base station 210 and the selected first user, i.e., the mobile device 120. The received quantized channel capacity is referred to a quantized projected channel capacity over the broadcast complementary orthogonal matrix. The base station 110 may be operable to select a mobile device having the strongest projected channel capacity as a second user for the user group from the remaining mobile devices. The selected second user is semi-orthogonal or approximately orthogonal to the selected first user in the user group.

The user selection process for the user group may be continued and one or more additional mobile devices may be added to the user group depending on the need and/or system capacity. Each mobile device within the user group may be approximately orthogonal (semi-orthogonal) to each other. The base station 110 may be operable to schedule corresponding downlink data transmissions intended for one or more mobile devices in the user group.

A multi-antenna mobile device such as the mobile device 120 may comprise suitable logic, circuitry and/or code that may be operable to communicate with a wireless communication network such as a WCDMA network via an associated serving base station such as the base station 110. The mobile device 120 may be operable to employ multiple available receive antennas, for example, the receive antennas 121a-121b, to concurrently receive multiple spatially independent data streams from the base station 110. The mobile device 120 may be operable to measure or estimate channel quality information, for example, channel direction, channel capacity, channel maximum mutual information rate, and/or CQI for each spatial subchannel of a single user downlink MIMO channel from the transmit antennas 111a-111b to the receive antennas 121a-121b. The channel quality measurement may be performed with respect to one or more specific beams broadcasted by the base station 110. Each channel quality measurement may be quantized according to capacity of a finite-rate feedback link, for example, so as to maximize throughput and/or increase processing speed and efficiency. The mobile device 120 may be operable to communicate or report the quantized channel quality measurements as quantized channel state information (CSI) over a finite-rate feedback link with the base station 110. Downlink data transmission intended for the mobile device 120 may be scheduled by the base station 110 according to the reported CSI from the mobile device 120.

In an exemplary operation, a multi-antenna base station such as the base station 110 may be operable to concurrently communicate with a plurality of associated multi-antenna mobile devices such as the mobile devices 120-140. The base station 110 may be operable to communicate multiple spatially independent data streams using multiple available antennas such as the antennas 111a-111b to the mobile devices 120-140. Each multi-antenna mobile device such as the mobile device 120 may be operable to generate user specific channel state information (CSI) for a single user downlink MIMO channel between the base station and the mobile device 120. The generated user specific CSI may comprise channel quality information such as channel capacity, channel direction information, projected channel capacity and/or projected channel direction information of the associated single user downlink MIMO channel. The mobile device 120 may be operable to quantize the generated user specific CSI according to the capacity of a finite-rate feedback link and/or application. The quantized CSI may be communicated with the base station 110 over the finite-rate feedback link.

The base station 110 may be operable to process the quantized CSI received from the multi-antenna mobile devices. The processed CSI may be utilized by the base station 110 to perform user group selection. A multi-antenna mobile device such as the mobile device 120, which is associated with the strongest channel capacity may be selected as a first user for a user group. Quantized channel direction information for the selected first user may be further reported to the base station 110. The base station 110 may be operable to calculate a complementary orthogonal matrix for the reported channel direction information from the selected first user. The calculated complementary orthogonal matrix indicating beams orthogonal to channel directions reported from the first selected user may be broadcasted. Each of the remaining mobile devices may be operable to generate quantized relative channel direction information and projected channel capacity with regard to the broadcast beams. The generated quantized relative channel direction information and projected channel capacity may be communicated or reported to the base station 110. The base station 110 may be operable to select a mobile device having the strongest projected channel capacity as a second user for the user group from the remaining mobile devices. The selected second user is semi-orthogonal or approximately orthogonal to the selected first user in the user group. The base station 110 may be operable to schedule and/or manage downlink data transmissions intended for the selected first user and/or the selected second user in the user group when need.

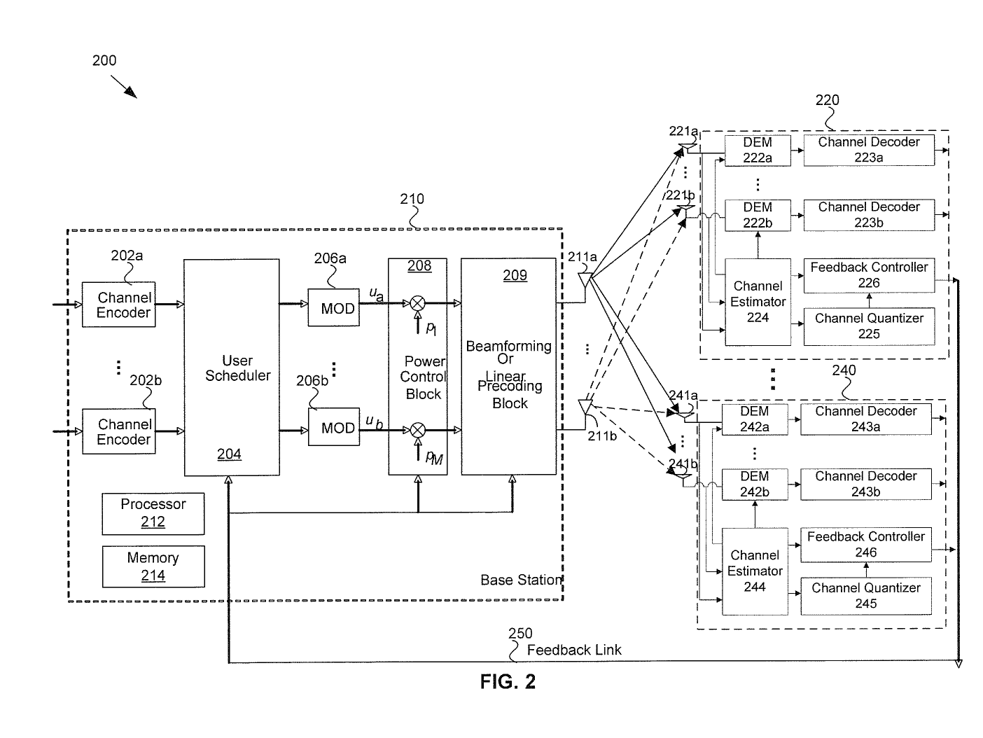

FIG. 2 is a block diagram illustrating an exemplary MIMO downlink transmission system that is operable to schedule downlink data transmissions to MIMO capable mobile devices according to corresponding quantized channel state information, in accordance with an embodiment of the invention. Referring to FIG. 2, there is shown a MIMO downlink communication system 200 comprising a base station 210, a plurality of mobile devices, of which mobile devices 220-240 are illustrated, and a feedback link 250.

The base station 210 may comprise a plurality of channel encoders 202a-202b, a user scheduler 204, a plurality of modulators (MOD) 206a-206b, a power control block 208, a beamforming or linear precoding block 210, a plurality of transmit antennas 211a-211b, a processor 212, and a memory 214.

A transmit antenna such as the transmit antenna 211 a may comprise suitable logic, circuitry, interfaces and/or code that may be operable to transmit a spatially independent data stream. The transmit antenna 211a may be scheduled and/or assigned to transmit a spatially independent data stream to receive antennas of selected mobile devices. In this regard, the transmit antenna 211a may be operable to transmit a spatially independent data stream over a plurality of spatial subchannels associated with a single user downlink MIMO channel between the base station 210 and a selected mobile device. For example, the transmit antenna 211a may be operable to transmit a spatially independent data stream over spatial subchannels between the transmit antenna 211a and each of the receive antennas 221a-221b, respectively, of the mobile device 220.

The channel encoder 202a may comprise suitable logic, circuitry, interfaces and/or code that may be operable to encode input binary data streams intended for mobile devices such as the mobile devices 220-240.

The user scheduler 204 may comprise suitable logic, circuitry, interfaces and/or code that may be operable to locate and/or select a user group from a plurality of associated mobile devices such as the mobile devices 220-240 so as to optimize system performance, for example, maximizing overall throughput of the system. The user scheduler 204 may be operable to perform user group selection according to quantized CSI provided or reported from the mobile devices 220-240 over the feedback link 250. A user (mobile device) having the strongest channel capacity may be selected as a first user in the user group. The user scheduler 204 may be operable to further acquire channel direction information from the selected first user. In return, the user scheduler 204 may be operable to receive quantized channel direction information from the selected first user. The received quantized channel direction information may indicate beams associated with a single user downlink MIMO channel between the base station 210 and the selected first user such as the mobile device 220. A complementary orthogonal matrix indicating beams orthogonal to the single user downlink MIMO channel between the base station 210 and the selected first user is broadcasted.

The user scheduler 204 may be operable to receive a quantized relative channel direction matrix and quantized projected channel capacity with respect to the broadcast complementary orthogonal matrix from each of the remaining mobile devices. The user scheduler 204 may be operable to select a mobile device having the strongest projected channel capacity as a second user for the user group from the remaining mobile devices. The selected second user is semi-orthogonal (approximately orthogonal) to the selected first user. The user scheduler 204 may be operable to schedule and/or manage downlink data transmissions intended for the selected first user and/or the selected second user in the user group according to corresponding system capacity information, for example.

A modulator such as the MOD 206a may comprise suitable logic, circuitry, interfaces and/or code that may be operable to modulate channel encoded binary data of a selected user (a selected mobile device).

The power control block 208 may comprise suitable logic, circuitry, interfaces and/or code that may be operable to control and/or manage power levels of different user signals according to corresponding channel quality information such as, for example, CSI received over the feedback link 150.

The beamforming or linear precoding block 210 may comprise suitable logic, circuitry, interfaces and/or code that may be operable to process data streams and separate the processed data streams into multiple spatially independent data streams for transmission. In instances where the base station 210 may be equipped with, for example, M available transmit antennas, where M is an integer and M>1, the beamforming or linear precoding block 210 may be operable to separate the processed data streams into at most M different spatially independent signals. In instances where each intended mobile device (receiver) may be equipped with, for example, N receive antennas, where N is an integer and N>1, a single user downlink MIMO channel between the base station 210 and an intended mobile device may comprise at most M×N spatial subchannels. The beamforming or linear precoding block 210 may be operable to transmit to at most M spatially independent data streams over M single user downlink MIMO channels comprising total M×N special subchannels, at a time. M or less mobile devices may be selected among associated mobile devices for downlink transmissions.

The processor 212 may comprise suitable logic, circuitry, interfaces and/or code that may be operable to manage and/or control operations of associated operation components such as, for example, the channel encoders 202a-202b and the user scheduler 204. The processor 212 may be operable to process and/or handle signals communicated between the base station 210 and a plurality of associated mobile devices such as the mobile devices 220-240.

The memory 214 may comprise suitable logic, circuitry, interfaces and/or code that may be operable to store information such as executable instructions and data that may be utilized by the processor 212. The executable instructions may comprise functions that may be applied to various signal processes such as user group selection and/or power control. The memory 214 may comprise RAM, ROM, low latency nonvolatile memory such as flash memory and/or other suitable electronic data storage.

Each mobile device such as, for example, the mobile device 220 may comprise a plurality of receive antennas 221a-221b, a plurality of demodulators (DEM) 222a-222b, a plurality of channel decoders 223a-223b, a channel estimator 224, a channel quantizer 225, and a feedback controller 226.

A receive antenna such as the receive antenna 221a may comprise suitable logic, circuitry, interfaces and/or code that may be operable to receive multiple spatially independent data streams. The receive antenna 221a may be scheduled and/or assigned to receive multiple spatially independent data streams from multiple available transmit antennas of the base station 210. In this regard, the receive antenna 221a may be operable to receive multiple spatially independent data streams over multiple spatial subchannels of a single user downlink MIMO channel between the mobile device 220 and the base station 210.

A DEM such as the DEM 222a may comprise suitable logic, circuitry, interfaces and/or code that may be operable to demodulate data streams received from the base station 210 via the receive antenna 221a. The DEM 22a may be operable to communicate the demodulated data streams with the channel decoder 223a.

A channel decoder such as the channel decoder 223a may comprise suitable logic, circuitry, interfaces and/or code that may be operable to decode the demodulated data streams from the DEM 222a and generate channel decoded signals.

A channel estimator such as the channel estimator 224 may comprise suitable logic, circuitry, interfaces and/or code that may be operable to generate a channel estimate for a single user downlink MIMO channel between the base station 210 and the mobile device 220. The channel estimator 224 may be operable to estimate channel state information (CSI) such as, for example, channel capacity, channel direction, signal-to-interference and noise ratio (SINR) and/or channel quality indicator (CQI) for each associated subchannel of the single user downlink MIMO channel. The channel estimator 224 may also be operable to calculate projected CSI estimate such as, for example, projected channel capacity and relative channel direction with regard to the broadcast beams from the base station 210. The CSI estimate may be communicated with the channel quantizer 225 and/or the feedback controller 226, respectively, for further processing.

A channel quantizer such as the channel quantizer 225 may comprise suitable logic, circuitry, interfaces and/or code that may be operable to quantize the CSI estimate from the channel estimator 224. The quantized CSI estimate may be communicated with the feedback controller 226. In instances where the mobile device 220 may be a candidate for a user group for downlink data transmission, the channel quantizer 225 may be operable to quantize channel direction information and/or channel capacity with respect to a broadcast complementary orthogonal matrix indicating orthogonal beams of a single user downlink MIMO channel between the base station 210 and, for example, a selected first user of the user group. The quantized channel direction information and/or the quantized channel capacity may be communicated with the base station 210 over the finite-rate feedback link 250.

A feedback controller such as the feedback controller 226 may comprise suitable logic, circuitry, interfaces and/or code that may be operable to generate quantized single user downlink MIMO channel CSI. In one embodiment of the invention, the generated quantized single user downlink MIMO channel CSI may be communicated with the base station 210 over the feedback link 250. The feedback controller 226 may be operable to communicate the generated quantized single user downlink MIMO channel CSI via various CSI transmission schemes. For example, the generated single user downlink MIMO channel CSI may be transmitted in full, differentially, or a combination thereof. The generated single user downlink MIMO channel CSI may be communicated or reported periodically or aperiodically. In another embodiment of the invention, the generated single user downlink MIMO channel CSI may be communicated with the base station 210 only when the change in the generated CSI exceeds a particular threshold. The CSI transmission scheme may be selected according to capacity of the feedback link 250, the generated quantized single user downlink MIMO channel CSI, and/or application types.

The feedback link 250 may comprise suitable logic, circuitry, interfaces and/or code that may be operable to communicate CSI from a plurality of associated mobile devices such as, for example, the mobile devices 220-240. In this regard, the feedback link 250 may be operable to communicate quantized single user downlink MIMO channel CSI reported from each associated mobile device. The reported quantized single user downlink MIMO channel CSI comprises channel quality information such as, for example, channel capacity, channel direction, SINR, and/or CQI for corresponding single user downlink MIMO channels, for example, the single user downlink MIMO channel between the base station 210 and the mobile device 220.

In an exemplary operation, a plurality of signals to be transmitted may be encoded using the channel encoders 202a-202b. The user scheduler 204 may be operable to schedule data transmissions among a plurality of associated mobile devices such as the mobile devices 220-240. The user scheduler 204 may be operable to schedule data transmissions according to various scheduling criteria such as fairness and channel quality information. In this regard, the user scheduler 204 may be operable to perform user group selection according to quantized channel status information reported by the mobile devices 220-240 over the feedback link 250. A mobile device having the strongest channel capacity may be selected as a first user in a user group for data transmissions. A mobile device having the strongest projected channel capacity in a semi-orthogonal group of the selected first user may be selected as a second user. The user scheduler 204 may be operable to schedule downlink data transmissions to the selected first user and/or the selected second user according to, for example, corresponding system capacity information.

Channel encoded data streams from the channel encoders 202a-202b may be modulated via the MODs 206a-206b, respectively. Signal power level on resulting modulated data streams may be adjusted or managed via the power control block 208. The beamforming or linear precoding block 210 may be operable process data streams from the power control block 208 and separate the processed data streams into multiple spatially independent data streams for transmission. The transmit antennas 211a-211b may be configured to transmit the multiple spatially independent data streams. In instances where a mobile device (receiver) such as the mobile device 220 may be selected to receive at least a portion of the multiple spatially independent data streams, each of the receive antennas 221a-221b may be scheduled and/or assigned to receive spatially independent data streams from available transmit antennas of the base station 210. Data streams received, for example, via the receive antenna 221a, may be demodulated via the DEM 22a. The demodulated data streams may be channel decoded via the channel decoder 223a. The channel estimator 224 may be operable to estimate channel state information (CSI) for each subchannel of the single user downlink MIMO channel between the base station 210 and the mobile device 220. The estimated subchannel CSI may be quantized via the channel quantizer 225. The feedback controller may be operable to generate quantized single user downlink MIMO channel CSI using the quantized subchannel CSI. The generated quantized single user downlink MIMO channel CSI may be communicated with the base station 210 over the feedback channel 250.

In instances where channel direction information with respect to beams orthogonal to a single user downlink MIMO channel between the base station 210 and the mobile device 220 may be required, the channel quantizer 225 may be operable to generate relative channel direction information, as required, with respect to the beams orthogonal to the single user downlink MIMO channel between the base station 210 and the selected first user. The generated relative channel direction information may be quantized to be communicated to the base station 210 over the finite-rate feedback link 250.

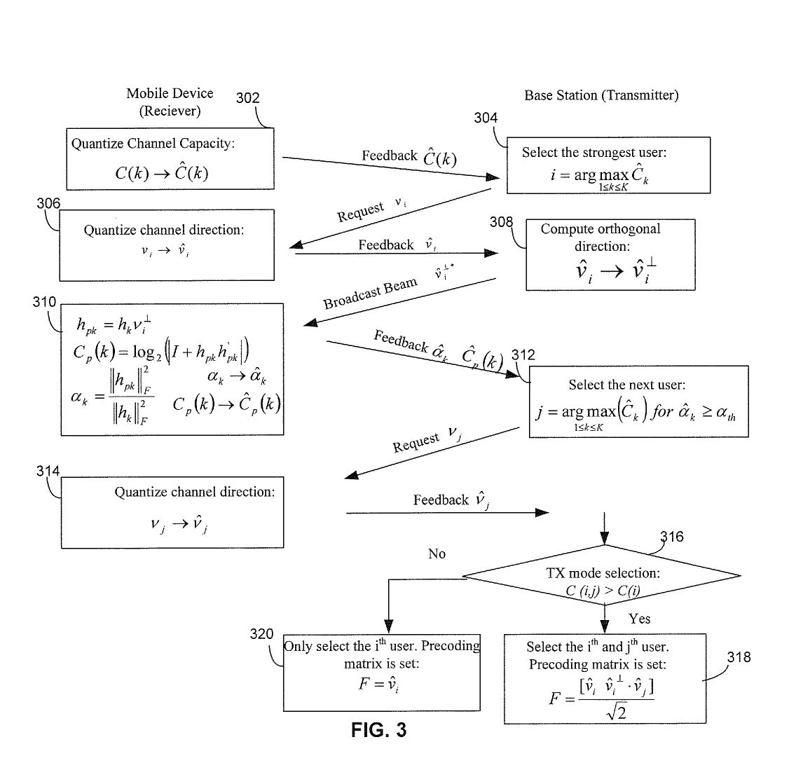

FIG. 3 is a flow diagram illustrating exemplary steps that are utilized to generate quantized channel state information for selecting a user group from MIMO capable mobile devices, in accordance with an embodiment of the invention. Referring to FIG. 3, each of the parameters i,j,k is mobile device (receiver) index, where 0<i,j,k≦K and a parameter K is the total number of mobile devices.

A parameter C(k) represents channel capacity of the kth mobile device. A parameter Ĉ(k) represents quantized channel capacity of the kth mobile device. A parameter ΔC indicates a capacity correction term. A parameter Cₚ(k) represents a projected channel capacity of the kth mobile device with respect to a broadcast channel direction from a base station. A parameter Ĉₚ(k) presents quantized Cₚ(k). A parameter C(i,j) represents the total mutual channel capacity or rate of the ith mobile device and the jth mobile device. A parameter Ĉ(i,j) represents quantized C(i,j). A parameter vₖ represents channel direction of the kth mobile device. A parameter \hat{v}ₖ represents quantized channel direction of the kth mobile device. A parameter αₖ represents an orthogonality measurement of the kth mobile device with respect to a broadcast channel direction from a base station. A parameter \hat{α}ₖ represents quantized αₖ. A parameter hₖ represents a channel impulse response matrix estimate of a single user downlink MIMO channel associated with the kth mobile device. A parameter hₚₖ represents a projected channel impulse response matrix with respect to a broadcast channel direction from a base station. A parameter ĥₚₖ represents quantized hₚₖ.

It may be assumed that the base station 210 may be operable to utilize M available antennas for downlink transmissions, where M is an integer and M>1. A mobile device such as the mobile device 220 may be operable to utilize N available antennas to receive downlink transmissions from the base station 210, where N is an integer. The channel impulse response matrix estimate, hₖ, of the single user downlink MIMO channel associated with the kth mobile device may be expressed as following

$${h}_{k} = [ \begin{matrix}{h}_{k} ( 1 , 1 ) & {h}_{k} ( 1 , 2 ) & … & {h}_{k} ( 1 , M ) \\ {h}_{k} ( 2 , 1 ) & {h}_{k} ( 2 , 2 ) & … & {h}_{k} ( 2 , M ) \\ … & & & \\ {h}_{k} ( N , 1 ) & {h}_{k} ( N , 2 ) & … & {h}_{k} ( N , M )\end{matrix} ] ,$$

where M is available transmit antennas and N is available receive antennas of the kth mobile device, and hₖ(i,j), (1≦i≦N,1≦j≦M) is channel impulse response estimate for a spatial subchannel between the ith transmit antenna of the base station 210 and the jth receive antenna of the kth mobile device.

The quantized channel capacity, Ĉ(k), may be calculated using, for example,

C(k)=log₂ (|I+hₖh′ₖ|)

Referring to FIG. 3, the exemplary steps start with step 302, an associated mobile device such as the kth mobile device may be operable to receive multiple spatially independent data streams from the base station 210 via available receive antennas such as the receive antennas 221a-221b. The channel estimator 224 may be operable to estimate channel status information (CSI) such as, for example, the channel capacity, C(k), of the kth mobile device. The estimated C(k) may be quantized into Ĉ(k) via the channel quantizer 225. The quantizer 225 may be configured to perform channel capacity and/or channel direction quantization by matching performance of the beamforming or linear precoding block 209 at the base station 210. The quantized channel capacity Ĉ(k) may be communicated as CSI with the base station 210 via a rate constrained feedback channel such as the feedback channel 250.

In step 304, the base station 210 may be operable to receive Ĉ(k), where 1≦k≦K. The user scheduler 204 may be operable to select, for example, the ith mobile device, which is associated with the strongest quantized channel capacity, i.e.,

$$i = arg {max}_{1 \leq k \leq K} {\hat{C}}_{k} ,$$

as a first user for a user group. The base station 210 may be operable to send a request to the selected first user, namely, the ith mobile device, for channel direction information associated with the single user downlink MIMO channel between the base station 210 and the ith mobile device. The requested channel direction may indicate direction information of a corresponding MIMO channel. For example, the channel direction, vₗ, of the lth mobile device may indicate direction information of the MIMO channel between the base station 210 and the lth mobile device.

In step 306, the selected first user, namely, the ith mobile device, may be operable to receive the request from the base station 210 for channel direction information. The lth mobile device may be operable to compute vₗ via, for example, taking the right singular vector matrix of hₗ. The computed vₗ may be matrix/vector quantized via, for example, the channel quantizer 225, to generate \hat{v}ₗ. A quantization resolution of, for example, Bᵥ bits per channel update, may be used for the matrix quantization on the computed vₗ. The lth mobile device may be operable to feedback the generated \hat{v}ₗ to the base station 210 over the feedback link 250.

In step 308, the base station 210 may be operable to receive the quantized matrix of \hat{v}ᵢ from the ith mobile device over the feedback link 250. The base station 210 may be operable to generate complementary orthogonal matrix \hat{v}ᵢ^{⊥} of the received matrix \hat{v}ᵢ. The \hat{v}ᵢ and the \hat{v}ᵢ^{⊥} are in different dimensions. For example, with 6 transmit antenna at the base station 210 and 2 receive antenna at the ith mobile device, the dimension of the \hat{v}ᵢ is a 6×2. The \hat{v}ᵢ and the \hat{v}ᵢ^{⊥} are of dimensions of 6×2 and 6×4, respectively. The base station 210 may be operable to utilize the generated orthogonal complementary matrix \hat{v}ᵢ^{⊥} as the beamforming matrix for the beamforming or linear precoding block 209. The base station 210 may also be operable to broadcast the generated orthogonal complementary matrix \hat{v}ᵢ^{⊥} to the entire serving area (cell).

In step 310, each associated mobile device such as the kth mobile device may be operable to receive the broadcast complementary orthogonal matrix \hat{v}ᵢ^{⊥}. A mobile device such as the kth mobile device may be operable to estimate a projection channel matrix h_{Pk}, given by h_{Pk}=hₖ\hat{v}ᵢ^{⊥}. The projection matrix h_{Pk} indicates relative channel direction information with respect to the received the broadcast complementary orthogonal matrix \hat{v}ᵢ^{⊥}. In order to measure the orthogonality of the channel directions between the k-th user and the i-th user, an orthogonality measurement αₖ may be calculated using, for example,

$${α}_{k} = \frac{{‖ {h}_{Pk} ‖}_{F}^{2}}{{‖ {h}_{k} ‖}_{F}^{2}} .$$

In addition, the kth mobile device may also be configured to compute a projected channel capacity give by, for example,

C_{P}(k)=log₂ (|I+h_{Pk}h′_{Pk}|)

The calculated orthogonality measurement αₖ and the calculated projected channel capacity C_{P}(k) may be quantized to \hat{α}ₖ and Ĉ_{P}(k), respectively, so as to be communicated to the base station 210 over the feedback link 250. The computation of the projected channel capacity C_{P}(k) may be optional at the mobile device kth mobile device. In instances where the kth mobile device may be configured not to support the computation of the projected channel capacity C_{P}(k), only the quantized orthogonality measurement \hat{α}ₖ may be transmitted to base station 210 over the feedback link 250.

In step 312, the base station 210 may be operable to receive quantized orthogonality measurement \hat{α}ₖ and/or the projected channel capacity Ĉ_{P}(k) from the remaining mobile devices. In instances where no quantized projected channel capacity C_{P}(k) may be received from the kth mobile device, the base station 210 may be configured to generate a projected channel capacity C_{P}(k) for the kth mobile device. The generated projected channel capacity C_{P}(k) may be used as corresponding quantized projected channel capacity Ĉ_{P}(k) for the kth mobile device for user selection. The user scheduler 204 may be operable to select a mobile device having the largest projected channel capacity from the set of users whose orthogonality measurement \hat{α}ₖ is beyond a certain threshold, i.e.,

$$j = arg {max}_{1 \leq k \leq K , k \neq i} {\hat{C}}_{P} ( k ) ,$$

such that \hat{α}ₖ≧αₜₕ, as a second user for the user group. The base station 210 may be operable to send a request to the selected second user, namely, the jth mobile device, for channel direction information associated with the single user downlink MIMO channel between the base station 210 and the jth mobile device.

In step 314, the selected second user, namely, the jth mobile device, may be operable to receive the request from the base station 210 for channel direction information. The jth mobile device may be operable to compute vⱼ, which may be, for example, the right singular vector matrix of h_{Pj}. The computed vⱼ may be matrix quantized via, for example, the channel quantizer 225, to generate \hat{v}ⱼ. The jth mobile device may be operable to feedback the generated \hat{v}ⱼ to the base station 210 over the feedback link 250.

In step 316, the base station may be configured to determine whether 2 users or 1 user may be supported based on the current channel condition. For example, it may be determined whether C(i,j)>C(i). The total mutual channel capacity or rate C(i,j) may be calculated by, for example,

C(i,j)=log₂ (|I+hᵢh′ᵢ/2|)+log₂ (|I+h_{Pj}h′_{Pj}/2|).

In instances where the base station 210 may not have the complete CSI information, the total mutual channel capacity or rate C(i,j) may be approximated by, for example,

C(i,j)≈log₂ (|I+hᵢh′ᵢ|)+log₂ (|I+h_{Pj}h′_{Pj}|)−ΔC≈Ĉ(i)+Ĉ_{P}(j)−ΔC,

where the parameter ΔC indicates a capacity correction term. The parameter ΔC may be determined based on, for example, SNR, SNIR and/or number if transmit/receive antennas, and may be implemented, for example, as a programmable register. In instances where C(i,j)>C(i), then in step 318, the base station 210 may be operable to allocate equal transmission power to both the ith mobile device and the jth mobile device to transmit multiple spatially independent data streams to the ith mobile device and the jth mobile device, respectively, over corresponding single user downlink MIMO channels. The base station 210 may be operable to set a precoding matrix as

$$F = \frac{[ {\hat{v}}_{i} {\hat{v}}_{i}^{⊥} \cdot {\hat{v}}_{j} ]}{\sqrt{2}} .$$

In step 316, in instances where C(i,j)≦C(i), then in step 320, the base station 210 may be operable to allocate full transmission power only to the ith mobile device to transmit multiple spatially independent data streams to the ith mobile device, over a corresponding single user downlink MIMO channel. The base station 210 may be operable to set a precoding matrix as F=\hat{v}ᵢ.

Although a user group of two users (mobile devices) is illustrated in FIG. 3, the invention may not be so limited. Accordingly, a user group comprising more than 2 users (mobile devices) may be supported without departing from the spirit and scope of various embodiments of the invention.

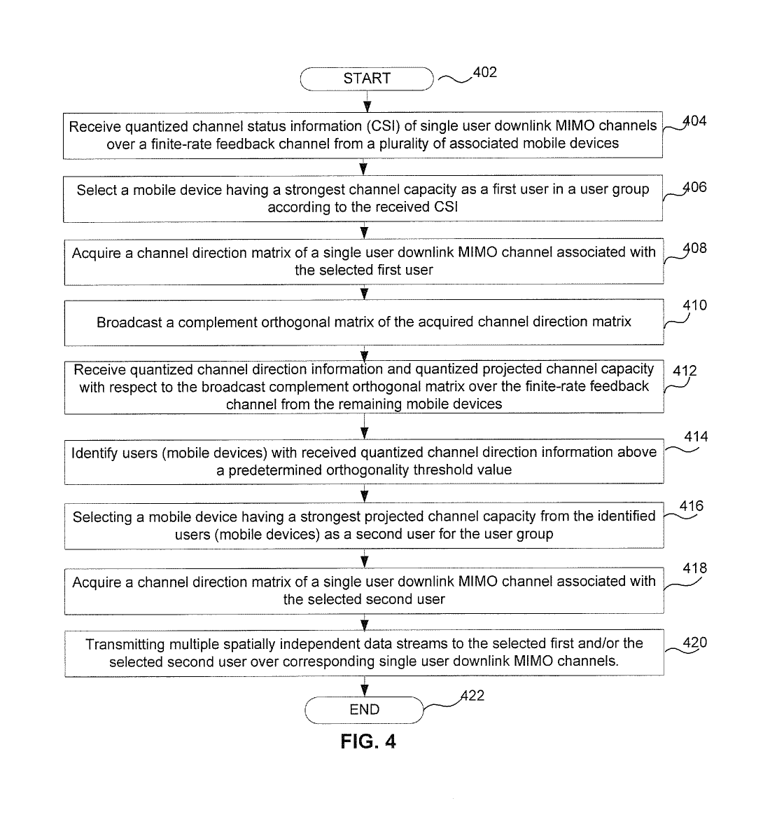

FIG. 4 is a flow diagram illustrating exemplary steps for selecting a user group from MIMO capable mobile devices using quantized channel state information, in accordance with an embodiment of the invention. Referring to FIG. 4, the exemplary steps start with step 402, the base station 210 may be equipped with multiple transmit antennas for transmitting multiple spatially independent data streams to one or more associated multi-antenna mobile devices. In step 404, the base station 210 may be operable to receive quantized channel status information (CSI) from a plurality of associated multi-antenna mobile devices. The received quantized CSI from a mobile device such as the mobile device 220 may indicate channel quality information such as channel capacity over the entire spatial subchannels of a single user downlink MIMO channel between the base station 210 and the mobile device 220. The CSI may be received over a finite-rate feedback channel such as the feedback channel 250. In step 406, the base station 210 may be operable to select a mobile device having the strongest channel capacity as a first user for a user group according to corresponding received CSI.

In step 408, the base station 210 may be operable to acquire a channel direction matrix of a single user downlink MIMO channel associated with the selected first user. In return, the base station 210 may be operable to receive a quantized channel direction matrix for the single user downlink MIMO channel associated with the selected first user. In step 410, the base station 210 may be operable to broadcast a complementary orthogonal matrix of the acquired channel direction matrix for the single user downlink MIMO channel associated with the selected first user.

In step 412, the base station 210 may be operable to receive quantized channel direction information and a quantized projected channel capacity with respect to the broadcast complementary orthogonal matrix from the remaining mobile devices over the finite-rate feedback channel 250. In step 414, the base station 210 may be operable to identify users (mobile devices) with received quantized channel direction information above a predetermined orthogonality threshold value. In step 416, the base station 210 may be operable to select a mobile device having the strongest projected channel capacity as a second user for the user group from the identified users. In step 418, the base station 210 may be operable to acquire channel direction information for the selected second user. In return, the base station 210 may be operable to receive quantized channel direction information from the selected second user. In step 420, the base station 210 may be operable to schedule and transmit multiple spatially independent data streams to the selected first and/or the second user in the user group according to channel capacity and/or mutual information rate of the two selected users. The exemplary steps end in step 422.

Aspects of a method and system for selecting a user group using quantized channel state information feedbacks from MIMO capable mobile devices are provided. In accordance with various embodiments of the invention, a communication device such as the mobile device 220 may be operable to estimate channel status information (CSI), utilizing the channel estimator 224, for a single user downlink multiple-input multiple-output (MIMO) channel from the base station 210 to the mobile device 220. The mobile device 220 may be operable to quantize the estimated CSI utilizing the channel quantizer 225 for the single user downlink MIMO channel. The feedback controller 226 may be configured to communicate the quantized CSI information to the base station 210 over a finite-rate feedback channel such as the feedback channel 250. The downlink data transmission may be scheduled by the base station 210 according to the transmitted CSI.

The mobile device 220 may be operable to receive the scheduled downlink data transmission via multiple available receive antennas such as the receive antennas 221a-221b. The estimated CSI comprise generalized channel quality information such as, for example, channel gain, channel direction, channel quality indicator (CQI), signal-to-noise ratio (SNR), signal-to-noise-interference ratio (SNIR), channel capacity, and/or channel maximum mutual information rate associated with the single user downlink MIMO channel from the base station 210 to the mobile device 220. The channel quantizer 225 may be operable to quantize the estimated CSI for the single user downlink MIMO channel using a finite quantization resolution such as a one bit quantization resolution.

The base station 210 may be operable to receive quantized CSI over the feedback channel from a plurality of associated communication devices such as the mobile devices 220-240. The user scheduler 204 of the base station 210 may be operable to select, from the plurality of associated mobile devices, a first user having a strongest channel capacity according to the received quantized CSI. A complementary orthogonal matrix, which corresponds to a single user downlink MIMO channel from the base station 210 to the selected first user, may be calculated. Beams indicated in the calculated orthogonal complementary matrix may be broadcasted to the entire serving area of the base station 210. In response, each remaining mobile device such as the mobile device 220 may be operable to generate a quantized relative channel direction matrix and quantized projected channel capacity with respect to the broadcast beams orthogonal to the single user downlink MIMO channel from the base station 210 to the selected first user. The generated quantized channel direction matrix and quantized projected channel capacity may be transmitted to the base station over the feedback link 250. The base station 210 may be configured to identify users (mobile devices) with quantized relative channel direction matrix greater than a predetermined threshold. The base station 210 may be operable to select a mobile device having a strongest projected channel capacity from the identified one or more mobile devices as a second user for the user group.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for selecting a user group using quantized channel state information feedbacks from MIMO capable mobile devices.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A method for processing signals in a communication system, the method comprising:
performing by one or more processors and/or circuits in a communication device:
estimating channel status information (CSI) for a single user downlink multiple-input multiple-output (MIMO) channel from a base station to said communication device;
quantizing said estimated CSI for said single user downlink MIMO channel;
transmitting said quantized CSI to said base station over a finite-rate feedback channel; and
receiving downlink data transmission from said base station according to said transmitted CSI.

2. The method according to claim 1, wherein said estimated CSI comprise channel gain, channel direction, channel quality indicator (CQI), signal-to-noise ratio (SNR), signal-to-noise-interference ratio (SNIR), channel capacity, and/or channel maximum mutual information rate associated with said single user downlink MIMO channel.

3. The method according to claim 2, comprising quantizing said estimated CSI for said single user downlink MIMO channel using a finite quantization resolution.

4. The method according to claim 1, wherein said base station receives quantized CSI over said finite-rate feedback channel from a plurality of associated communication devices.

5. The method according to claim 4, wherein said base station selects, from said plurality of associated communication devices, a first user having a strongest channel capacity according to said received quantized CSI.

6. The method according to claim 5, wherein said base station broadcasts a plurality of beams orthogonal to another single user downlink MIMO channel from said base station to said selected first user.

7. The method according to claim 6, comprising generating a quantized relative channel direction matrix and quantized projected channel capacity for said single user downlink MIMO channel according to said broadcast plurality of beams if said communication device is not said first user; and transmitting said generated quantized relative channel direction matrix and said generated quantized projected channel capacity to said base station over said finite-rate feedback channel.

8. The method according to claim 6, wherein said base station receives quantized relative channel direction matrices and corresponding quantized projected channel capacity over said finite-rate feedback channel from a remaining portion of said plurality of communication devices subsequent to said broadcasting.

9. The method according to claim 8, wherein said base station identifies one or more communication devices with corresponding quantized relative channel direction matrices greater than a predetermined threshold.

10. The method according to claim 9, wherein said base station selects, from said identified one or more communication devices, a second user having a strongest projected channel capacity.

11. A system for signal processing, the system comprising:
one or more processors and/or circuits for use within a communication device, wherein said one or more processors and/or circuits are operable to estimate channel status information (CSI) for a single user downlink multiple-input multiple-output (MIMO) channel from a base station to said communication device;
said one or more processors and/or circuits are operable to quantize said estimated CSI for said single user downlink MIMO channel;
said one or more processors and/or circuits are operable to transmit said quantized CSI to said base station over a finite-rate feedback channel; and
said one or more processors and/or circuits are operable to receive downlink data transmission from said base station according to said transmitted CSI.

12. The system according to claim 11, wherein said estimated CSI comprise channel gain, channel direction, channel quality indicator (CQI), signal-to-noise ratio (SNR), signal-to-noise-interference ratio (SNIR), channel capacity, and/or channel maximum mutual information rate associated with said single user downlink MIMO channel.

13. The system according to claim 12, wherein said one or more processors and/or circuits are operable to quantize said estimated CSI for said single user downlink MIMO channel using a finite quantization resolution.

14. The system according to claim 11, wherein said base station receives quantized CSI over said finite-rate feedback channel from a plurality of associated communication devices.

15. The system according to claim 14, wherein said base station selects, from said plurality of associated communication devices, a first user having a strongest channel capacity according to said received quantized CSI.

16. The system according to claim 15, wherein said base station broadcasts a plurality of beams orthogonal to another single user downlink MIMO channel from said base station to said selected first user.

17. The system according to claim 16, wherein one or more processors and/or circuits are operable to generate a quantized relative channel direction matrix and quantized projected channel capacity for said single user downlink MIMO channel according to said broadcast plurality of beams if said communication device is not said first user; and transmitting said generated quantized relative channel direction matrix and said generated quantized projected channel capacity to said base station over said finite-rate feedback channel.

18. The system according to claim 16, wherein said base station receives quantized relative channel direction matrices and corresponding quantized projected channel capacity over said finite-rate feedback channel from a remaining portion of said plurality of communication devices subsequent to said broadcasting.

19. The system according to claim 18, wherein said base station identifies one or more communication devices with corresponding quantized relative channel direction matrices greater than a predetermined threshold.

20. The system according to claim 19, wherein said base station selects, from said identified one or more communication devices, a second user having a strongest projected channel capacity.
